(19) United States
(12) Patent Application Publication
(10) Pub. No.: US 2007/0112681 A1
(43) Pub. Date: May 17, 2007

(54) Content distribution system, license distribution method and terminal device

(76) Inventors: Satoshi Niwano, Osaka (JP); Ryuichi Okamoto, Osaka (JP); Katsumi Tokuda, Osaka (JP); Hiroki Murakami, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/581,881

(22) PCT Filed: Dec. 16, 2004
(86) PCT No.: PCT/JP04/19287

§ 371 Date: Jun. 6, 2006

(30) Foreign Application Priority Data
Jan. 8, 2004 (JP) 2004-003431

(51) Int. Cl. G06Q 99/00

(52) U.S. Cl. 705/59

(57) ABSTRACT

The transmission format A license conversion unit (430) of the terminal device (120) converts the transmission format license (710), which is obtained from the license relay server (110), described in a transmission format into a processing format license (510) to be specified by the conversion format specification information (711) and detects modifications on the license whose format has already been converted by performing a signature verification on the after-conversion processing format license (510) using a processing format signature (712).

### TECHNICAL FIELD

The present invention relates to a system for distributing a digital content (described as “content” from here) such as an encrypted video and music, and a license including at least a content use condition and a content key used in encrypting contents using broadcasting and communication, especially relates to a system including a terminal device that converts the format of the received license.

### BACKGROUND ART

With a recent digital network, a system for distributing contents to a user terminal device has proposed. Here, a terminal device is an apparatus including at least a CPU, a memory and software for controlling the terminal device. In the content distributing system like this, contents are encrypted and distributed from a content provider to a user terminal device, and a corresponding license is distributed to the terminal device of the user who purchased the content. Here, a license is data including at least a content use condition and a content key used in encrypting the content. For example, a content provider generates the data as a license issuer.

A content use condition is a condition relating to content use such as “available up to three times”. The terminal device includes a license processing unit that judges the availability of the content based on the license use condition and control use of the content key.

In this way, the method for using a content using a license as expected by the license issuer is called Digital Rights Management (DRM), and a plurality of DRM methods are provided.

Content providers have a request that they distribute encrypted contents and licenses using a plurality of distribution paths in order to increase chances that users purchase contents, a method for distributing them using broadcasting and communication has provided.

In general, a license format and a license processing method are prescribed by a designer of the DRM format, but, for example, another format used on a license transmission path (described as “transmission format” from here) may be predescribed by a distributor and so on like in the case of an example of a transmission method, in broadcasting, of a content key determined by the Ministry of Public Management, Home Affairs, Posts and Telecommunications, in addition, a transmission format of a license may be changed to another one according to the distributing path even employing a single DRM format.

Conventionally, as disclosed in the patent document “Japanese Laid-Open Patent application No. 2001-202088” or “Secure Electronic Commerce-Building the Infrastructure for Digital Signatures and Encryption” (written by Warwick Ford and Michael S. Baum, published by Piason Education Co., 1997), in the case where each distributor uses a different format of use condition, the format of the received use condition is converted into the same unique format in order to enable a terminal device to perform the same processing on those use conditions.

In the case where the terminal device receives a plurality of licenses of transmission formats, converting the formats of these received licenses of the transmission formats into a common format (described as “processing format” from here) for performing the same processing makes it possible to improve the efficiency of the processing performed by the terminal device because of the provided commonality of the license processing.

### DISCLOSURE OF INVENTION

However, as the security must be secured for every DRM format in the case where the terminal device processes the licenses in a plurality of DRM formats, each license processing unit in each DRM format independently processes a license, and thus a different processing format may be used for every DRM format. Also, depending on the DRM format, a plurality of processing formats may be described even for a single DRM format because processing are divided by each service.

In a conventional method, in the case where the terminal device converts a format of a license into a processing format, there is a problem that a license issuer cannot specify a processing format of a license for every license.

Further, even in the case where the license issuer can specify the license processing format used for the terminal device for every license, there is no method for verifying the descriptions of the license generated by the format conversion by the terminal device, there is a problem that no modification can be detected.

In order to solve conventional problems like this, an object of the present invention is to provide a content distributing system enabling specification of a conversion format of the license by the license issuer and detection of license modifications performed in the format conversion in the content distributing system for converting the format of licenses by the terminal device.

In order to solve this problem, in the present invention, the content distribution system includes a license management server, a relay server and a terminal device. The license management server includes a first license generation unit that generates, in a first format, a first license for controlling content use in the terminal device. The relay server includes a second license generation unit that generates, in a second format, a second license by adding, to the first license, modification detection information for detecting a modification of the first license, the second format being different from the first format. The terminal device includes a format conversion unit that obtains the second license from the relay server and converts a format of the second license into the first format, a judgment unit that judges presence or absence of the modification of the first license whose format is converted by the format conversion unit, and a use unit that uses the content according to the first license in the case where the judgment unit judges that no modification is made.

In this way, with the content distributing system of the present invention, the second license includes the modification detection information for detecting the modification of the first license. The terminal device can judge presence or absence of modifications of the first license obtained by converting the format of the second license into the format of the first license based on the modification detection information.

Also, in the content distribution system, the license management server may further include a modification detection information generation unit that generates modification detection information for detecting the modification of the first license and further sends the generated modification detection information to the relay server depending on a transmission path to the terminal device.

In this way, the relay server generates the second license only when receiving the modification detection information from the license management server. This makes it possible to enable the terminal device to obtain the second license according to the transmission path between the license management server and the terminal device.

Also, in the content distribution system, in the case where a frequency band of the transmission path is narrower than a predetermined frequency band or a communication speed of the transmission path is slower than a predetermined communication speed, the modification detection information generation unit may send the modification detection information to the relay server and instructs the relay server to generate the second license.

In this way, in the case where the frequency band of the transmission path between the license management server and the terminal device is narrower or the communication speed of the transmission path is slower, it is possible to enable the terminal device to obtain the second license.

Also, in the content distribution system, the second license generation unit may generate the second license whose data size is smaller than a data size of the first license generated in the first format.

In this way, even in the case where the frequency band of the transmission path between the relay server and the terminal device is narrower or the communication speed of the transmission path is slower, the second license can be sent without troubles.

Further, in the content distribution system, the license management server may include a first sending unit that sends the first license to the terminal device, the relay server may include a second sending unit that sends the second license to the terminal device via the transmission path different from the transmission path in the case of using the license management server, and the terminal device may obtain the second license from the second sending unit.

In this way, the terminal device can obtain the second license via a transmission path different from a transmission path in the case of using the license management server according to the status of the transmission path between the license management server and the terminal device.

Also, in the content distribution system, the license management server may further include a specification information receiving unit that receives an input of format specification information that is an instruction, to the terminal device, for converting the format of the second license into the first format. The second license generation unit may generate a second license including the format specification information received by the license management server. The format conversion unit may convert the format of the second license into the first format according to the format specification information added to the second license.

In this way, as the license server includes a specification information receiving unit that receives inputs of the format specification information for converting the format of the second license into the format of the first license, it enables the license issuer to specify the processing format (the first format) of the license for the terminal device. Also, as to the second license obtained in a format different from the format of the first license used for use control of the contents in the terminal device, the format conversion unit of the terminal device converts the format of the second license into the format of the first license according to the format specification information added to the second license. This makes it possible to provide the commonality of license processing in the terminal after receiving these formats on condition that the format of each license is the specified first format.

Further, in the content distribution system, the modification detection information may be a digital signature of the first license, the license management server may include a signature generation unit that generates the digital signature, and the second license generation unit may generate a second license including the digital signature.

In this way, as a digital signature of the first license is added to the second license, to the terminal device can detect modifications of the first license using the digital signature after converting the format of the distributed second license into the first format (processing format).

Further, in the content distribution system according to claim 1, further including a plurality of servers, one of which is the relay server according to claim 1, each of the relay servers may include an “n”th license generation unit that generates an “n”th (“n” is a natural number that is 2 or greater) license, in an “n”th format, generated by adding, to the first license, modification detection information for detecting the modification of the first license, the “n”th format different from the first format. The format conversion unit may obtain the “n”th license from one of the relay servers and converts the format of the “n”th license into the first format.

In this way, in the terminal device, it is possible to detect modifications of the first licenses based on the modification detection information added to the “n”th license after the format conversion unit converts the format of the “n”th license into the format of the first license even in the case where the “n”th license is obtained from one of a plurality of relay servers.

Also, the license management server of the present invention in a license management server in a content distribution system including: the license management server; a relay server; and a terminal device. The license management server distributes a first license for controlling content use in a terminal device. The relay server generates, in a second format, a second license by adding, to the first license, modification detection information for detecting a modification of the first license, the second format being different from a format used when the first license is generated, and distributes the second license. The terminal device generates the first license by format transformation by obtaining the second license, detects presence or absence of the modification of the generated first license based on the modification detection information, and, in the case where no modification is detected, uses the content according to the first license. The license management server includes: a first license generation unit that generates, in a first format, the first license; and a modification detection information generation unit that generates modification detection information of the first license and send the generated modification detection information to the relay server.

Also, in this invention, the relay server in a content distribution system including: a license management server; the relay server; and a terminal device. In the relay server, the license management server distributes a first license for controlling content use in a terminal device. The relay server generates, in a second format, a second license generated by adding, to the first license, modification detection information for detecting a modification of the first license, the second format being different from a format used when the first license is generated, and distributes the second license. The terminal device generates the first license by format transformation by obtaining the second license, detects presence or absence of the modification of the generated first license based on the modification detection information, and, in the case where no modification is detected, uses the content according to the first license. The relay server includes: a second license generation unit that generates, in the second license, the second license by adding, to the first license, the modification detection information of the first license generated in the first format; and a second sending unit that sends the generated second license to the terminal device.

Also, in the present invention, the terminal device in a content distribution system including: a license management server; a relay server; and the terminal device. In the terminal device, the license management server distributes a first license for controlling content use in the terminal device. The relay server generates a second license generated, in a second format, by adding, to the first license, modification detection information for detecting a modification of the first license, the second format being different from a format used when the first license is generated, and distributes the second license. The terminal device uses the content according to the first license by obtaining the second license and generates the first license using format conversion, and includes: a format conversion unit that obtains the second license generated in the second format from the relay server, converts a format of the obtained second license into a first format different from the second format, and generates the first license; a judging unit that judges presence or absence of the modification of the generated first license based on modification detection information added to the second license; and a use unit that uses the content according to the first license in the case where the judgment unit judges that no modification is made.

Note that the present invention not only can be realized as a content distribution system like this but also can be realized as a license management server, a license relay server and a terminal device that are included in the content delivery system, as a license distribution method where unique units in the content distribution system like this are regarded as corresponding steps, or as a program causing a computer to execute these steps. In addition, the program like this can be distributed via a recording medium such as a CD-ROM or a transmission medium such as the Internet.

### Further Information about Technical Background to this Application

The disclosure of Japanese Patent Application No. 2004-003431 filed on Jan. 1, 2004 including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing the outline structure of the whole content distributing system in an embodiment of the present invention;

FIG. 2 is a diagram showing the structure of the license management server in the embodiment;

FIG. 3 is a diagram showing the structure of the license relay server in the embodiment;

FIG. 4 is a diagram showing the structure of the tamper-proof unit of the terminal device in the embodiment;

FIG. 5 is a diagram showing the description example of the processing format license;

FIG. 6 is a diagram showing the description example of the processing format license body and the processing format signature in XML language;

FIG. 7 is a diagram showing a description example of the transmission format license;

FIG. 8 is a diagram showing an example of the encrypted content structure;

FIG. 9 is a communication sequence diagram of the outline procedure showing how the terminal device uses a content using the processing format license in the case where the transmission band between the license management server and the terminal device is wide;

FIG. 10 is a communication sequence diagram showing how the terminal device uses a content using the transmission format license distributed via the license replay server;

FIG. 11 is a flow chart showing the processing by the license management server;

FIG. 12 is a flow chart showing the processing by the license relay server;

FIG. 13 is a flow chart of the processing showing how the terminal device receives the content and uses the content using the processing format license; and

FIG. 14 is a flow chart of the processing showing how the terminal device receives the content and uses the content using the transmission format license.

### BEST MODE FOR CARRYING OUT THE INVENTION

The embodiment of the present invention will be explained below with reference to figures.

### Embodiment

Note that a common key encryption algorithm such as Advanced Encryption Standard (AES) and Data Encryption Standard (Triple DES) is generally used as a content encryption method described in the following description, and a common key encryption algorithm such as RSA and Elliptic Curve Digital Signature Algorithm (EC-DSA) is generally used as a digital signature method. The processing explained below is not for a specific encryption method. Also, Secure Hash Algorithm 1 (SHA-1), MD5 and the like is used for a hash calculation method and this embodiment is not for a specific hash calculation.

Also, in this embodiment, a Secure Authenticated Channel (described as “SAC” from here) such as a Secure Socket Layer (SSL) is established in order to secure the security when a license is sent or received, and at least a content key is encrypted at the time of communication using an encryption key that is shared with the receiving side or an encryption key that is previously shared between components. Detailed explanations on a digital signature and modification detection using the digital signature and the SAC are included in “Secure Electronic Commerce-Building the Infrastructure for Digital Signatures and Encryption” (written by Warwick Ford and Michael S. Baum, published by Piason Education Co., 1997).

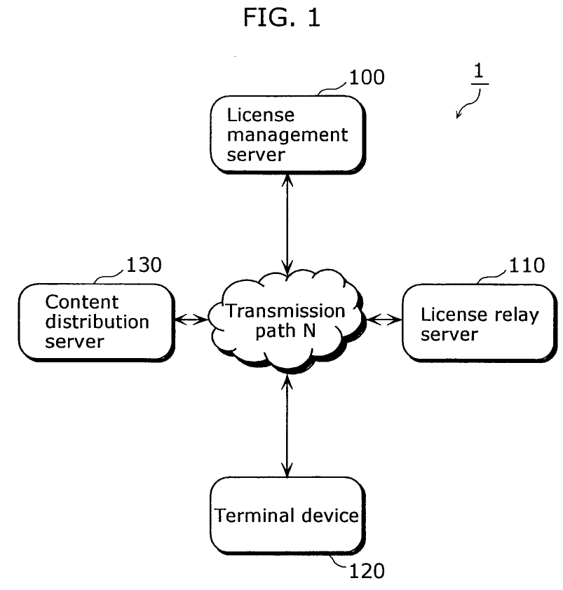

FIG. 1 is a diagram showing the structure of the whole content distribution system 1 in this embodiment. As shown in FIG. 1, even in the case where the license is distributed in a different format via a transmission path different from the one used in the case where a license is distributed from the license management server 100 directly to the terminal device 120, the content distribution system 1 makes it possible to convert the format of a license into a format specified by the license management server 100 in the terminal device 120 and avoid any license modification by format conversion. The content distribution system 1 includes a license management server 100, a license relay server 110, a terminal device 120 and a content distribution server 130, and they are connected with each other by the transmission path N.

The license management server 100 is set at the license issuer side of the content provider and the like, and performs at least receiving the content information from the content distribution server 130, generating the corresponding license, sending the license to the license relay server 110 and distributing the license to the terminal device 120. The content information is the data including at least a content ID and a content key.

The license relay server 110 is an apparatus set at a distributor and the like, and performs at least receiving the license generation information from the license management server 100, converting the license generation information into the license, distributing the license to the terminal device 120. The license generation information is the one where descriptions of the generated license are described in a format predetermined between the license management server 100 and the license relay server 110.

The terminal device 120 performs receiving the encrypted contents and licenses, converting the format of the license from transmission format to a processing format, and using the encrypted contents.

The content distribution server 130 is an apparatus set at the content provider and the like, and performs at least generating the encrypted contents, sending the content information to the license management server 100, and sending the encrypted contents to the terminal device 120.

The transmission path N is a communication network such as the Internet, digital broadcasting or a multiplexed network.

Note that a Certification Authority (CA) server, which is not shown in any figure, that manages a common key certification, a common encryption key and the like, and a key management server and the like are connected to the transmission path N in the content distribution system 1, but they will be not explained in detail in this embodiment because they are not focused on in this invention.

Next, each unit of the content distribution system 1 will be explained.

(Component 1) License Management Server 100

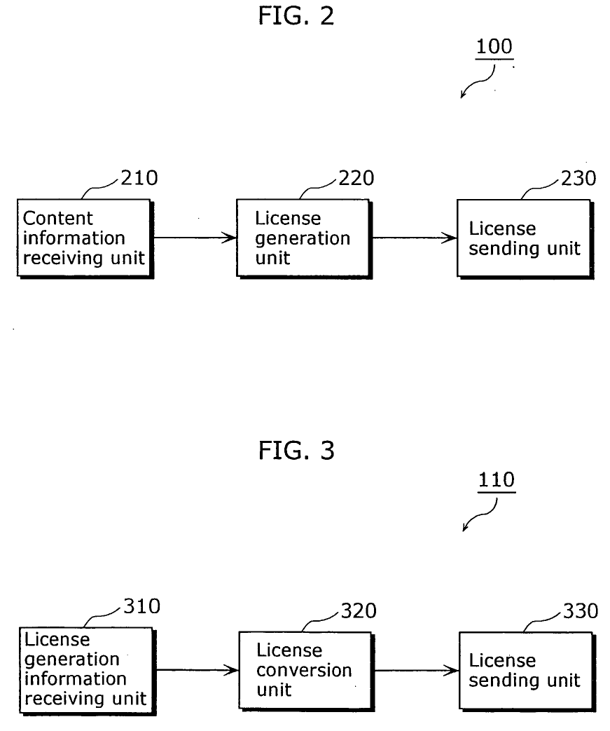

FIG. 2 is a diagram showing the structure of the license management server 100 in this embodiment.

In FIG. 2, the content information receiving unit 210 receives content information from the content distribution server 130.

The license generation unit 220 generates license generation information to be sent to the license relay server 110 based on the content information and the use condition set by the license issuer. Also, it generates a processing format license 510 to be distributed to the terminal device 120 in the case where the transmission path to the terminal device 120 has a wide frequency band.

The license sending unit 230 sends the license generation information to the license relay server 110 and the processing format license 510 to the terminal device 120 respectively. Note that the license management server 100 distributes the processing format license 510 directly to the terminal device 120 only when the license management server 100 and the terminal device 120 are connected by, for example, the transmission path of a wide frequency band. In other cases, a transmission format license is distributed to the terminal device 120 via the license relay server 110.

(Component 2) License Relay Server 110

FIG. 3 is a diagram showing the structure of the license relay server 110 in this embodiment.

In FIG. 3, the license generation information receiving unit 310 receives the license generation information from the license management server 100.

The license conversion unit 320 generates the transmission format license 710 based on the license generation information received from the license management server 100.

The license sending unit 330 sends the transmission format license 710 to the terminal device 120.

Note that this embodiment describes the case where the license relay server 110 generates the transmission format license 710, but the same effect can be obtained also in the case where the license generation unit 220 of the license management server 100 generates a transmission format license 710 although the license conversion unit 320 is included in the license management server 100 and the license generation information receiving unit 310 receives the transmission format license 710.

(Component 3) Terminal Device 120

The terminal device 120 includes a tamper-proof unit 410 and a non-secure unit that is not shown in any figure. The non-secure unit serves as a user interface.

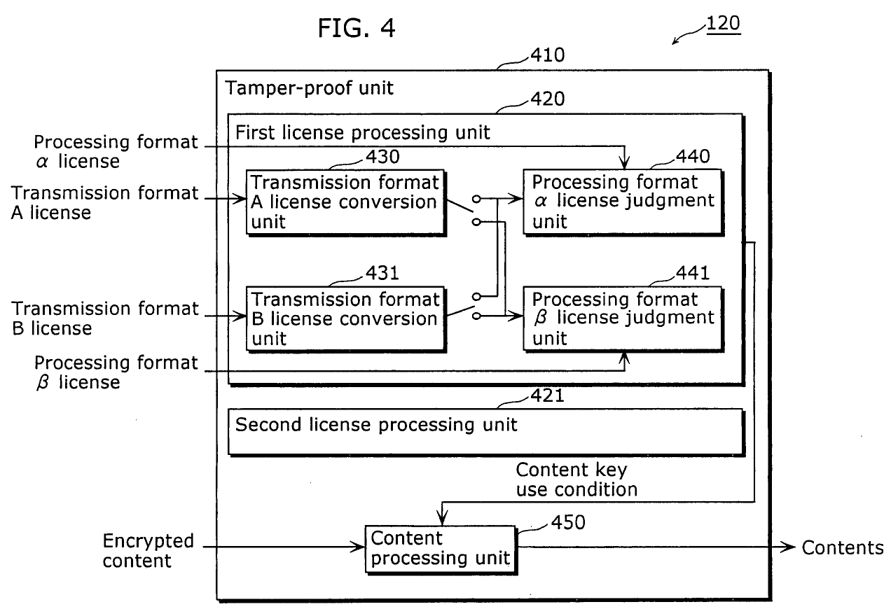

FIG. 4 is a diagram showing the structure of the tamper-proof unit 410 of the terminal device 120 in this embodiment.

In FIG. 4, the tamper-proof unit 410 includes a first license processing unit 420, a second license processing unit 421 and a content processing unit 450.

The first license processing unit 420 includes (i) a set of a transmission format A license conversion unit 430 and a transmission format B license conversion unit 431 that receive the transmission format license 710 and convert the format of the license and (ii) a set of a processing format α license judgment unit 440 and a processing format β license judgment unit 441 that receive and judge the processing format license 510.

Here, the license judgment processing means sending a use condition judgment and a content key to the content processing unit 450.

Note that the tamper-proof unit 410 is implemented in the terminal device 120 in two ways: it is set in the terminal device in an undetachable way; and it is set as a portable module such as an IC card, but a similar effect can be obtained in both cases in this invention.

Note that the first license processing unit 420 and the content processing unit 450 are implemented in a single tamper-proof unit 410 in this embodiment, but a similar effect can be obtained even in the case where the first license processing unit 420 and the content processing unit 450 are implemented in another tamper-proof unit as long as the data communicated between the first license processing unit 420 and the content processing unit 450 is secured safely.

The first license processing unit 420 includes a transmission format A license conversion unit 430, a transmission format B license conversion unit 431, a processing format α license judgment unit 440 and a processing format β license judgment unit 441 as this embodiment describes a case where the first license processing unit 420 corresponds to a transmission format A, a transmission format B, a processing format α and a processing format β, but a similar effect can be obtained on condition that the license processing unit includes at least a single transmission format license conversion unit and a single processing format license judgment unit. Also, in contrast, the license processing unit may include three or more transmission format license conversion units and three or more processing format license judgment units, and in this case, it is possible to correspond to the license distribution via various kinds of transmission path.

The second license processing unit 421 has the same structure as the first license processing unit 420 while it processes licenses in a DRM format different from the ones processed by the first license processing unit 420, and it will not be explained in detail in the embodiment.

Note that the tamper-proof unit 410 includes the first license processing unit 420 and a second license processing unit 421 as the embodiment describes the terminal device 120 corresponds to the two DRM format, a similar effect can be obtained on condition that there is at least a single license processing unit.

The content processing unit 450 decodes the encrypted content using a content key and uses the contents based on the use condition.

Note that the embodiment describes the case where the terminal device 120 includes a single content processing unit 450, but a similar effect can be obtained also in the case where it includes a different content processing unit 450 for each DRM format.

(Component 4) Content Distribution Server 130

The content distribution server 130 generates content information and the encrypted contents 810, and distributes the content information to the license management server 100 and the encrypted content 810 to the terminal device 120.

Next, the data stored in each component of the content distribution system 1 will be explained.

(Data 1) Processing Format License 510

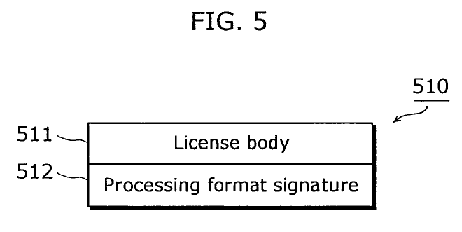

FIG. 5 is a description example of the processing format license 510.

The processing format license 510 is used for the processing in at least the tamper-proof unit 410 of the terminal device 120. Also, the processing format license 510 includes a license body 511 and a processing format signature 512.

Use condition and a content key are described in the license body 511.

The digital signature of the license issuer corresponding to the license body 511 is described in the processing format signature 512 and it is used for modification detection of the license body 511.

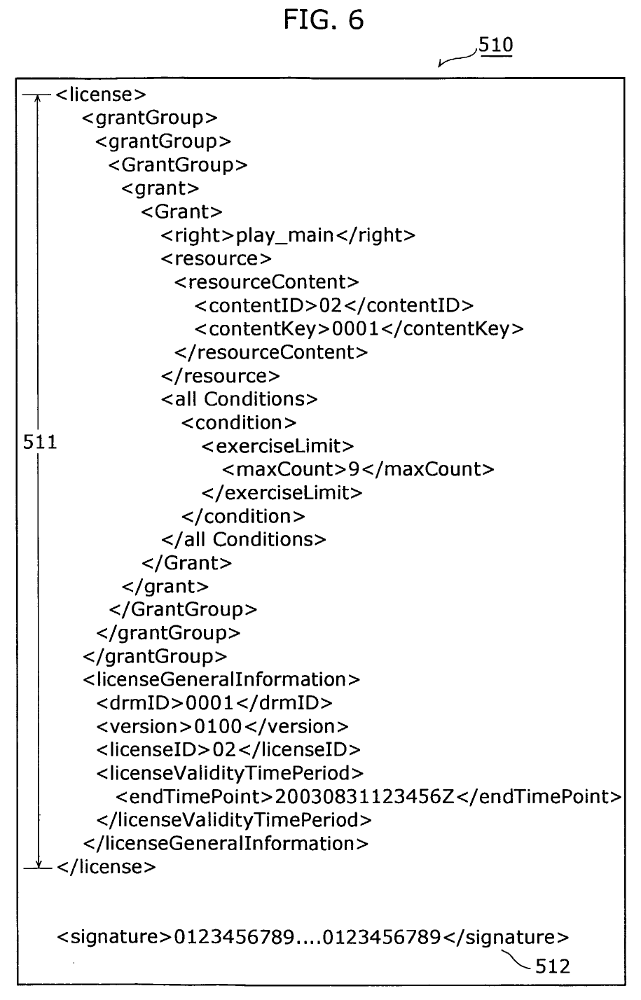

FIG. 6 is a description example of the license body 511 and the processing format signature 512 in XML language.

Note that an example where the processing format license 510 is described in XML language is shown in this embodiment, but another description format may be used on condition that a use condition and a content key can be described.

In FIG. 6, <right> shows a use method such as content replay or move to another medium, <content ID> shows a content ID used for identifying a content, <contentKey> shows a content key used in decoding the encrypted content, <maxCount> shows the maximum number of uses of the content, <drmID> shows an identifier for identifying the DRM format, <version> shows a version of the license format, <license ID> shows a license ID used for identifying the license, <endTimePoint> shows the end time of the license, and <signature> shows the processing format signature 512. This license is the license whose ID is “02” described in a Ver 1.0 license format in “0001” DRM format, and the content whose ID is “02” shows that the content can be used up to nine times until 12:34:56 of Aug. 31th, 2003, and the content key necessary for decoding this content is “0001”.

Note that adding a new tag enables adding an information item except the one shown in FIG. 6.

(Data 2) Transmission Format License 710

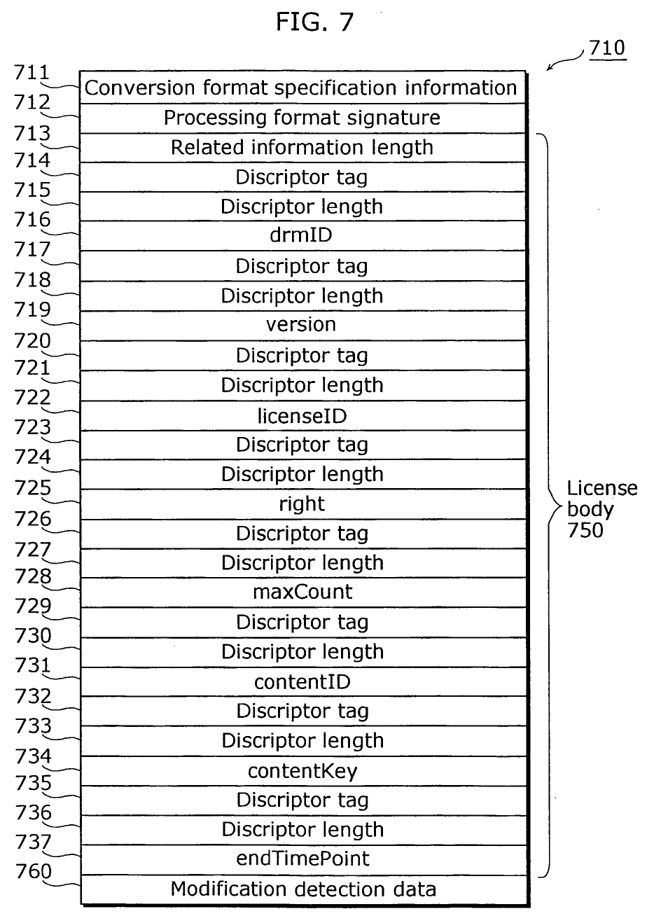

FIG. 7 is a description example of the transmission format license 710 whose descriptions are the same as the description example of the processing format license in FIG. 6 generated by the license relay server 110 based on the license generation information received from the license management server 100.

The transmission format license 710 includes a conversion format specification information 711, a processing format signature 712, a license body 750 and a modification detection data 760.

The conversion format specification information 711 is the information for specifying the transmission format when the transmission format license transformation unit of the terminal device 120 converts the processing format signature 712 of the transmission format license 710 and the information item included in the license body 750 into a processing format. For example, in the case of converting the processing format signature 712 and the information item included in the license body 750, the identifier “α” for specifying the processing format α is stored.

Note that this embodiment describes the case where the conversion format specification information 711 is the identifier for specifying the processing format, but a similar effect is obtained even in the case of a flag for specifying two values as to whether the license should be converted or not in a DRM format where only a single processing format is included.

The processing format signature 712 is the same data as the processing format signature 512 of the processing format license 510.

The license body 750 corresponds to the license body 511, and each corresponding value is stored in the following way in the embodiment: drm ID 716 is included in <drmID>; version 719 is included in <version>; license ID 722 is included in <license ID>; right 725 is included in <right>; maxCount 728 is included in <maxCount>; content ID 731 is included in <content ID>; content Key 734 is included in <contentKey>; and endTimePoint 737 is included in <endTimePoint>.

Note that a similar effect can be obtained even in the case where each value of the license body 750 is different from the corresponding value of the license body 511 on condition that the license body 511 after format conversion in the terminal device 120 matches the license body 511 generated by the license management server 100. Therefore, in the case where the conversion rule of the format conversion is shared between the license relay server 110 and the terminal device 120, for example, the license ID of the license body 511 is determined as “02”, and the identification number of the license relay server 110 that is not explained in this embodiment is determined as “01”. In addition, on condition that the license ID of the license body 750 is generated by adding the ID of the license relay server 110 to the leading part of the license ID in the license body 511, even in the case where the license ID of the license body 750 is determined as “0102” according to this conversion rule, a similar effect can be obtained as long as the license ID of the license body 511 is determined as “02” by deleting “01” from the header of the license ID of the license body 750 corresponding to the identification number of the license relay server 110 when the terminal device 120 converts the format from the license body 750 to the license body 511.

Note that the value of the license body 511 matches the corresponding value of the license body 750 in this embodiment, but each value of the license body will not be explained in the following explanation.

The identifier for identifying “drmID” is stored in the descriptor tag 714, the byte length of the “drmID716” is stored in the descriptor length 715, the identifier for identifying “version” is stored in the descriptor tag 717, the byte length of the “version 719” is stored in the descriptor length 718, the identifier for identifying the license ID is stored in the descriptor tag 720, the byte length of the “licenseID722” is stored in the descriptor length 721, the identifier for identifying “right” is stored in the descriptor tag 723, the byte length of “right 725” is stored in the descriptor length 724, the identifier for identifying “maxCount” is stored in the descriptor tag 726, the byte length of “maxCount 728” is stored in the descriptor length 727, the identifier for identifying “contentID” is stored in the descriptor tag 729, the byte length of “contentID731” is stored in the descriptor tag 730, the identifier for identifying “contentKey” is stored in the descriptor tag 732, the byte length of “contentKey734” is stored in the descriptor length 733, an identifier for identifying “endTimePoint” is stored in the descriptor tag 735, and the byte length of “endTimePoint737” is stored in the descriptor 736.

The modification detection data 760 is a hash value of the byte queue from the conversion format specification information 711 to the byte queue immediately before the modification detection data 760 and used for detecting modification of the transmission format license 710.

Note that a hash value is used as the modification detection 710 in this embodiment, a similar effect can be obtained as long as it is the data that can detect a modification such as a digital signature.

Note that adding a descriptor tag to the transmission format license 710 enables adding an information item except the one shown in FIG. 7.

Note that this embodiment explains the case where the transmission format license 710 is described in a descriptor style, but a similar effect can be obtained even in the case of using another description style as long as at least a conversion format specification information 711 and a processing format signature 712 are included.

Note that the transmission format license 710 is used as an example of a transmission format A license in this embodiment, but another license of a transmission format provides a similar effect as long as it has a similar data structure as the transmission format license 710 including at least the conversion format specification information 711 and the processing format signature 712.

(Data 3) Encryption Content 810

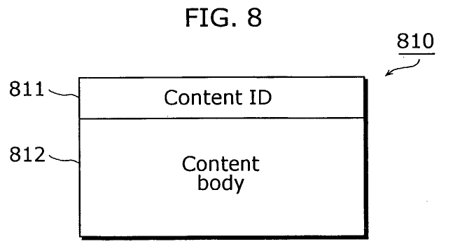

FIG. 8 is a diagram showing an example of the structure of the encrypted content. The encrypted content 810 includes a content ID 811 and a content body 812 as shown in FIG. 8 and the content body 812 is encrypted using the content key.

The content ID 811 is used for associating the license with the encrypted content 810. The content body 812 is digital data of video or music.

Note that the case where the encrypted content 810 includes the content ID 811 in this embodiment, a similar effect can be obtained even in the case of using a structure where the encrypted content 810 does not include the content ID 811 as long as it is possible to associate the encrypted content 810 with the processing format license 510 using another method.

(Data 4) License Generation Information

the license generation information is the data to be sent from the license management server 100 to the license relay server 110 in order to generate the transmission format license 710, and includes at least a conversion format specification information 711, a processing format signature 512 and the data whose descriptions are the same as the license body 511 that is not shown in any figure.

Note that the format of the license generation information can provide a similar effect also in the case of using a specific format that is predetermined between the license management server 100 and the license relay server 110.

Next, the processing of each component of the content distribution system 1 will be explained.

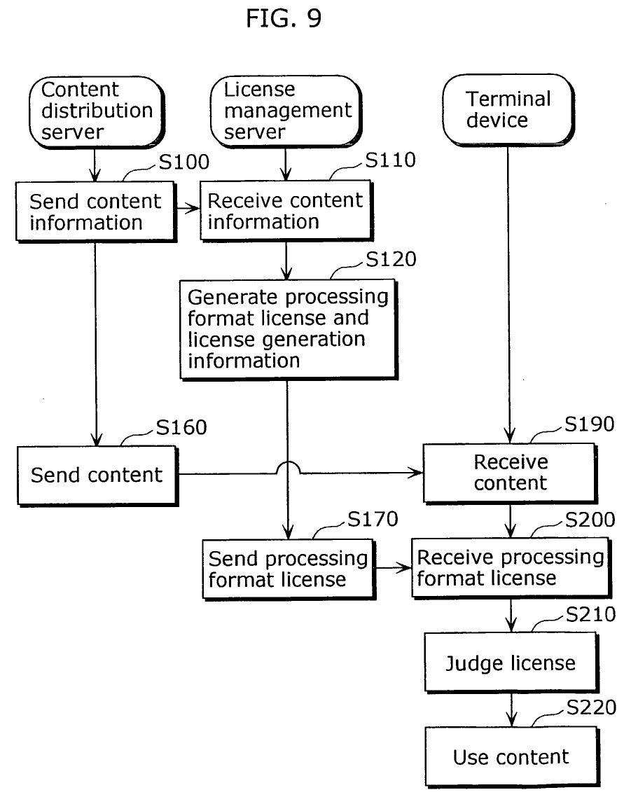

The outline of (i) the processing starting from generating the encrypted contents and generating the corresponding processing format license to using the content and (ii) the data transmission in the content distribution system 1 is performed according to, for example, the procedure shown in FIG. 9. FIG. 9 is a communication sequence diagram showing the outline procedure of how the terminal device uses the content using the processing format license in the case where the transmission band between the license management server and the terminal device is wide.

The content distribution server 130 generates a content, a content key and a content ID 811, generates a content body 812 by encrypting the content using the content key, and then generates an encrypted content 810 based on the content ID 811 and the content body 812. After that, it sends the content information that includes at least a content ID 811 and a content key in all the generated data to the license management server 100 (step S100).

Note that the case where the content ID 811 is sent from the content distribution server 130 to the license management server 100 as content information in this embodiment, but a similar effect can be obtained also in the case where the license management server 100 generates the content ID 811 and sends it to the content distribution server 130, and the content distribution server 130 associates the encrypted content with the content ID 811.

The content distribution server 130 distributes the encrypted content to the terminal device 120 (step S160).

The license management server 100 receives the content information from the content distribution server 130 (step S110) and generates the processing format license 510 and the license generation information to be sent to the license relay server 110 (step S120).

The license management server 100 distributes the processing format license 510 to the terminal device 120 (step S170).

The terminal device 120 receives the encrypted content from the content distribution server 130 (step S190).

The terminal device 120 receives the processing format license 510 from the license management server 100 (step S200), judges its availability based on the license use condition (step S210) and controls the use of the content received from the terminal device 120 (step S220).

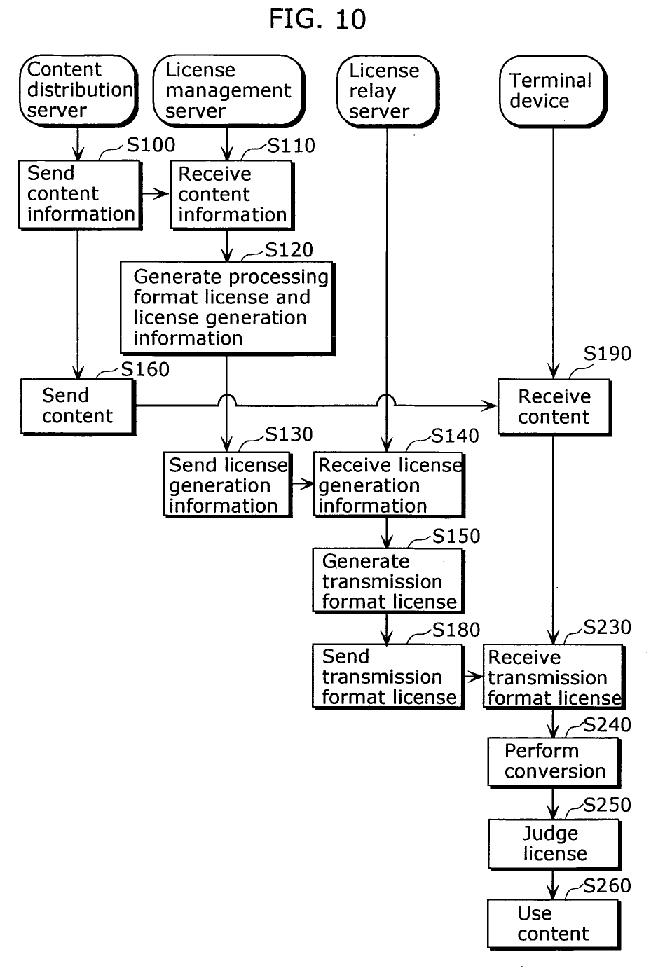

Also, the outline of (i) the processing starting from generating the encrypted contents and the transmission format license to using the contents in the content distribution system 1 and (ii) the data transmission will be performed using the procedure shown in FIG. 10. FIG. 10 is a communication sequence showing the outline procedure how the terminal device uses the contents using the transmission format license distributed via the license relay server.

The content distribution server 130 generates a content, a content key and a content ID 811, generates a content body 812 by encrypting the content using a content key, and then generates the encrypted content 810 from the content ID 811 and the content body 812. After that, it sends the content information including at least the content ID 811 and the content key in all the generated data to the license management server 100 (step S100).

The content distribution server 130 distributes the encrypted content to the terminal device 120 (step S160).

The license management server 100 receives the content information from the content distribution server 130 (step S110). After that, it temporally generates a processing format license and generates the corresponding license generation information (step S120), and then it sends the license generation information to the license relay server 110 in the case where the license is distributed via the license relay server 110 (step S130).

The license relay server 110 receives the license generation information (step S140) and generates the transmission format license 710 (step S150).

The license relay server 110 distributes the transmission format license 710 to the terminal device 120 (step S180).

The terminal device 120 receives the encrypted contents from the content distribution server 130 (step S190).

The terminal device 120 receives the transmission format license 710 from the license relay server 110 (step S230), converts it into the processing format license (step S240), judges its availability based on the license use condition and the like (step S250), and controls the use of the content received from the content distribution server 130 (step S260).

Next, the processing operation of each component of the content distribution system 1 will be explained with reference to figures.

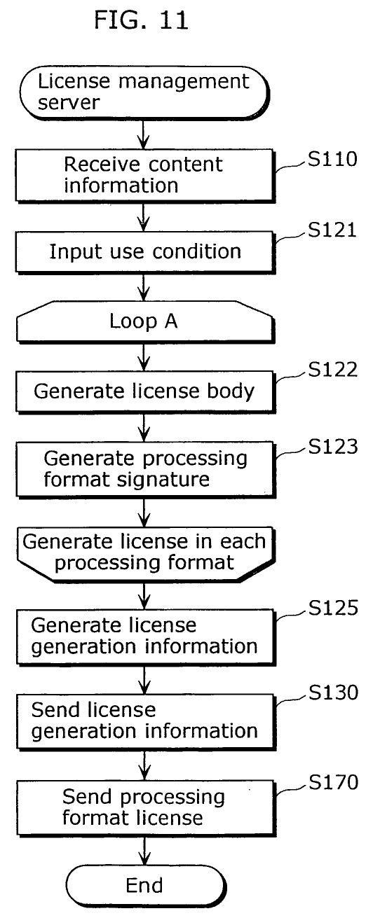

The processing of the license management server 100 will be explained with reference to FIG. 11. FIG. 11 is a flow chart showing the processing of the license management server.

(Content Information Receiving S110)

The license management server 100 receives the content information from the content distribution server 130 (step S110).

(License Generation S120)

The license issuer inputs the use condition corresponding to the content information received from the content distribution server 130 to the license management server 100 (step S121).

The license management server 100 generates the license body 511 using a processing format based on the content information received from the content distribution server 130 and the use condition inputted by the license issuer (step S122), and then generates the processing format signature 512 corresponding to the license body 511 (step S123). In the license management server 100 in DRM format including a plurality of processing formats, generation processing of the processing format license 510 (loop A) starting from step S122 to step S123 is repeatedly performed on each of the processing format.

As this embodiment describes a DRM format including a processing format α, and a processing format β to be processed in the first license processing unit 420, two processing format licenses 510 are generated in step S124, and thus a similar effect can be obtained as long as at least a single processing format license 510 is generated.

Next, the license management server 100 generates license generation information for sending a license to the license relay server 110 based on the processing format license 510 generated in the loop A in the case where the transmission path to the terminal device 120 that is the sending destination of the license is narrow. To be more specific, the license management server 100 converts the license body 511 of the processing format license 510 into a format prescribed between the license relay server 110 and the license management server 100 that are sending destinations, adding the corresponding processing format signature 512 and the conversion format specification information 711 to each processing format, and generates the license generation information (step S125).

(License Generation Information Sending S130)

The license management server 100 sends the license generation information generated in the step S125 to the license relay server 110.

(Processing Format License Sending S170)

Next, the license management server 100 sends the processing format license 510 to the terminal device 120 in the case where the transmission band to the terminal device 120 is wide. The processing format license 510 is a format corresponding to the processing format license judgment unit that is a sending destination. The license management server 100 sends the processing format license 510 of the processing format α because this embodiment describes the case where the sending destination is the processing format α license judgment unit 440 of the first license processing unit 420.

Note that a similar effect, which is different from the one obtained in the case where the sending destination is the processing format α license judgment unit 440, can be obtained even in the case where the processing format license 510 different from the processing format α is sent.

Note that there are two cases of sending the processing format license 510: the case where the license management server 100 sends it according to the request from the terminal device 120; and the case where the terminal device 120 receives the processing format license 510 which is broadcast by the license management server 100, but this invention is not for a specific communication method, and thus any of the methods for communicating the processing format license 510 can provide a similar effect.

Note that there are two cases of specifying a processing format license judgment unit even in the case where the terminal device 120 includes a plurality of processing format license judgment units. One of these cases is according to a communication protocol prescribed in respective DRM format and processing format, and another case is based on an identifier described in the processing format license 510 such as <drmID> and <version> in this embodiment. As this invention is not for a specific communication method, a similar effect can be obtained irrespective of how the processing format license judgment unit is specified.

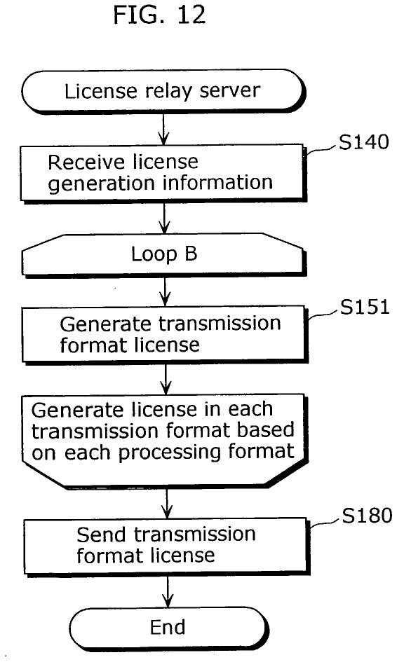

The processing of the license relay server 110 will be explained with reference to FIG. 12. FIG. 12 is a flow chart showing the processing of the license relay server 110.

(License Generation Information Receiving S140)

The license relay server 110 receives the license generation information from the license management server 100.

(Transmission Format License Generation S150)

The license relay server 110 generates a license body 750 in a transmission format, and then generates a transmission format license 710 by adding a conversion format specification information 711, a processing format signature 712 and a modification detection 760 to the license body 750 (S151).

Note that this embodiment includes a modification detection 760 generated by adding the license relay server 110 to the transmission format license 710 in order to detect a modification in the transmission path N, but a similar effect can be obtained even in the case where there is no modification detection 760 in the transmission format license 710 depending on a communication method of the transmission format license 710, for example, in the case where no modification in the transmission path N is detected.

In the case where the license management server 100 corresponds to a plurality of processing formats and the license relay server 110 corresponds to a plurality of transmission formats, the license relay server 110 repeats generating a transmission format license 710 with same descriptions (loop B), as to each processing format and each transmission format.

(Transmission Format License Sending S180)

Next, the license relay server 110 sends a transmission format license 710 to the terminal device 120. The transmission format license 710 is a format corresponding to the transmission format license conversion unit that is the sending destination. As this embodiment describes the case where the sending destination is the transmission format A license conversion unit 430 of the first license processing unit 420, the format is determined as the transmission format license 710 of the transmission format A license.

Note that, in the case where the license relay server 110 sends the transmission format license 710 of the format different from the transmission format A, a similar effect, which is different from the one obtained in the case where the sending destination is the transmission format A license conversion unit 430, can be obtained.

Note that there are two cases of sending the transmission format license 710: the case where the license relay server 110 sends it according to the request from the terminal device 120; and the case where the terminal device 120 receives the transmission format license 710 which is broadcast by the license relay server 110, but this invention is not for a specific communication method, and thus any of the methods for communicating the transmission format license 710 can provide a similar effect.

Note that, even in the case where the terminal device 120 includes a plurality of transmission format license conversion units, there are two cases of specifying a transmission format license conversion unit. One of these cases is according to a communication protocol prescribed in respective DRM format and transmission format, and another case is based on an identifier described in the transmission format license 710 such as <drmID716> and <version719> in this embodiment. As this invention is not for a specific communication method, a similar effect can be obtained irrespective of how the transmission format license conversion unit is specified.

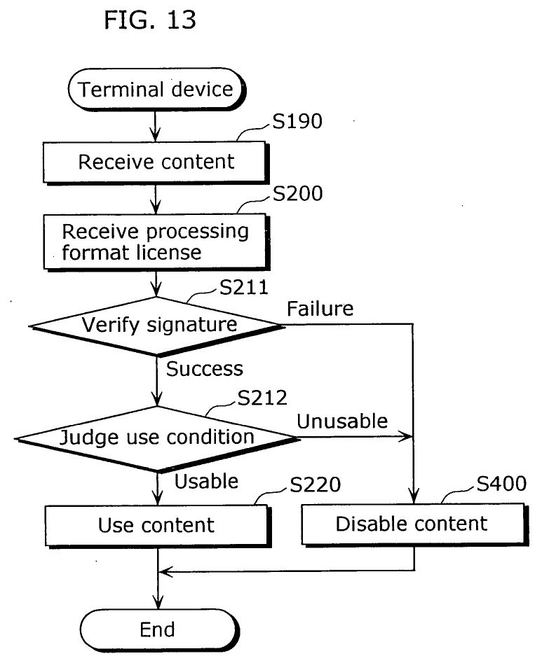

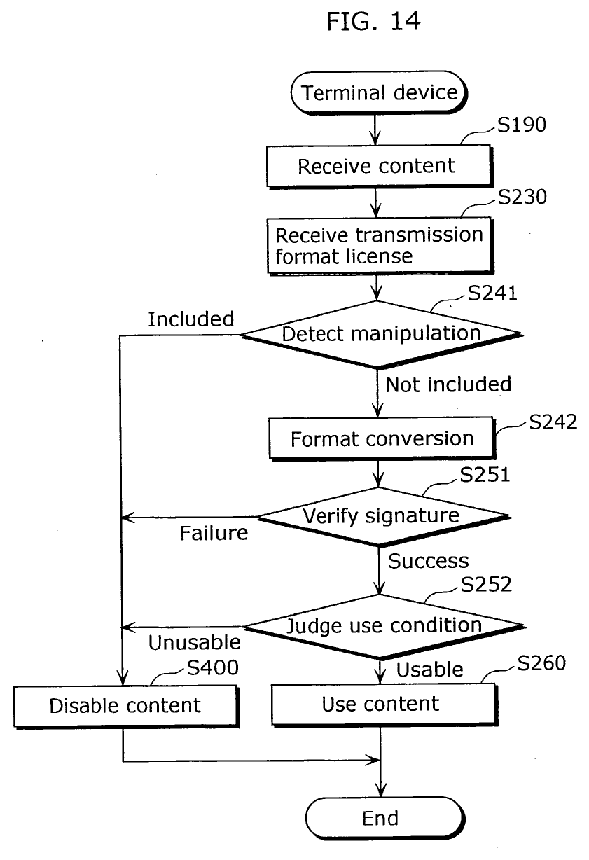

Next, more detailed explanation of the terminal device 120 that has already been explained in FIG. 9 and FIG. 10 will be made with reference to FIG. 13 and FIG. 14. FIG. 13 is a flow chart showing the processing of the terminal device 120 starting from receiving contents to using the contents using the processing format license 510.

(Content Receiving S190 in FIG. 9)

The terminal device 120 receives the encrypted contents 810 from the content distribution server 130.

(Processing Format License Receiving S200 in FIG. 9)

The processing format α license judgment unit 440 of the first license processing unit 420 in the terminal device 120 receives the processing format license 510 described in the processing format α from the license management server 100.

(License Judgment S210 in FIG. 9)

The processing format α license judgment unit 440 verifies the received processing format license 510 using the processing format signature 512 (step S211).

Note that, as this embodiment is not for a specific signature verification method, a similar effect can be obtained irrespective of which signature verification method is used as long as at least a common key verification and a Certificate Revocation List (CRL) that are used for signature verification are obtained.

In the case where signature verification fails because a modification is detected, content use is cancelled (step S400).

Verifying that no modification is performed means a success in signature verification, the processing format α license judgment unit 440 understands that the license is valid until 12:34:56, Aug. 31, 2003, and it can be used up to nine times according to the processing format license 510. Providing that the present time is 12:34:56, Aug. 1, 2003, and it is the first use, the processing format α license judgment unit 440 judges that the license can be used (step S212) and sends a content key and the use condition prescribing the content use in the content processing unit to the content processing unit 450.

In the case where it judges that the license cannot be used, it cancels the content use (step S400).

Note that, as the present invention is not for a specific judgment method as to time and the number of uses, a similar effect can be obtained irrespective of which judgment method is used as long as an unauthentic judgment can be avoided.

(Content Use s220 in FIG. 9)

The content processing unit 450 decodes the encrypted content 810 using a content key and controls the content use based on the use condition.

Note that, it becomes possible to verify the relation between the license and the content before using the content by storing the content ID in the use condition.

FIG. 14 is a flow chart showing the processing of how the terminal device uses the content using the transmission format license.

(Content Receiving S190 in FIG. 10)

The terminal device 120 receives the encrypted content 810 from the content distribution server 130.

(Transmission Format License Receiving S230 in FIG. 10)

The transmission format A license conversion unit 430 of the first license processing unit 420 in the terminal device 120 receives the transmission format license 710 described in the transmission format A from the license relay server 110.

(Conversion Processing S240 in FIG. 10)

The transmission format A license conversion unit 430 detects modifications of the received transmission format license 710 using the modification detection data 760 (step S241), and it cancels the content use in the case where any modification is detected (step S400).

In the case where no modification is detected, the transmission format A license conversion unit 430 converts the transmission format license 710 into a processing format license 510 based on the conversion format specification information 711 included in the transmission format license 710 (step S242). In this embodiment, the identifier for identifying the processing format α is included in the conversion format specification information 711, and the transmission format license 710 of the transmission format A is converted into the processing format license 510 of the processing format α.

Note that, as this invention is not for a specific format conversion method, a similar effect can be obtained irrespective of which format conversion method is used as long as the after-conversion transmission format license 710 matches the processing format license 510 generated in the license management server 100.

Note that this embodiment enables specifying the processing format at a distributor by specifying the processing format in the terminal device 120 by the conversion format specification information 711, but this invention is not limited to this. In other words, the processing format converted by the transmission format A license conversion unit 430 is specified in the conversion format specification information 711, but, in the case where a conversion table is previously set in the transmission format A license conversion unit 430, it is possible to convert the transmission format license 710 into the processing format license 510 even in the case where the transmission format license 710 does not include any conversion format specification information 711 in the case where a conversion table is previously set in the transmission format A license conversion unit 430.

Note that the conversion program in the transmission format license conversion unit and the judgment program in the processing format license judgment unit are updated by being downloaded from the license management server 100 and the license relay server 110 or by their physical modules being replaced in the case where their license formats are changed.

Also, in general, licenseID722 of the transmission format A license is a value different from the license ID of the processing format license 510 because of format conversion. However, the licenseID722 of the transmission format A license returns to the same value as the license ID of the processing format license 510 because of format conversion in the terminal device 120. Therefore, the license can be managed using the license ID generated by the license management server 100 after the format conversion, and thus the license management server 100 can uniformly manage the license of the terminal device 120 even in the case where the licenseID722 of the transmission format A license is different from the license ID of the processing format license 510.

(License Judgment S250 in FIG. 10)

The processing format α license judgment unit 440 verifies the received processing format license 510 using the processing format signature 512 (step S251).

Note that, as this invention is not for a specific signature verification method, a similar effect can be obtained irrespective of which signature verification method is used as long as at least a common key certification and Certificate Revocation List (CRL) that are used for the signature verification are obtained.

In the case where signature verification fails because a modification is detected, content use is cancelled (step S400).

Verifying that no modification is performed means a success in signature verification, the processing format α license judgment unit 440 understands that the license is valid until 12:34:56, Aug. 31, 2003, and it can be used up to nine times according to the processing format license 510. Providing that the present time is 12:34:56, Aug. 1, 2003, and it is the first use, the processing format α license judgment unit 440 judges that the license can be used (step S252) and sends a content key and the use condition prescribing the content use in the content processing unit to the content processing unit 450.

In the case where it judges that the license cannot be used, it cancels the content use (step S400).

(Content Use S260 in FIG. 10)

The content processing unit 450 decodes the encrypted content 810 using a content key and controls the content use based on the use condition.

Note that, the above-mentioned embodiment explained that a license is distributed using a processing format in the case where the transmission band between the license management server 100 and the terminal device 120 is wide, and that the license is distributed in a transmission format via the license relay server 110 in the case where the transmission band is narrow, but, to be more specific, this may be previously determined in a contract for each terminal device 120. For example, a license is sent in a processing format to the terminal device 120 to which the license is distributed according to the contract from the license management server 100 using the communication circuit of a wide frequency band such as the Internet as a transmission path, in contrast, a license is sent in a processing format to the terminal device 120 to which the license is distributed according to the contract to the terminal device 120 using the communication path of a narrow frequency band, the communication path being, for example, Entitlement Control Message (ECM) of digital broadcasting. Also, for example, the license management server 100 may distribute the transmission format license via the license relay server 110 when the communication circuit is crowded by monitoring the degree of congestion of the communication circuit at a certain interval.

### INDUSTRIAL APPLICABILITY

The content distribution system in the present invention is useful for specifying a processing format of the license by a license issuer in the terminal device 120 and as a content distribution system that is capable of achieving commonality of the received license processing in the terminal device.

Also, the content distribution system in this invention is used as a content distribution system capable of license modification detection by digital signature after converting the format, which is different from the processing format, of the distributed license into a processing format.

Further, the content distribution system concerning this invention is used as a content distribution system where the license management server can uniformly manage the licenses of the terminal device even in the case where the license is the one distributed in a different format.

In other words, the content distribution system concerning the present invention is useful as a content distribution system that distributes a license for controlling the content use via a plurality of transmission path such as the Internet and digital broadcasting. Also, the license management server of the present invention is useful as a license management server set in the content distribution system like this. Further, the license relay server of the present invention is useful as a server, which is set at a broadcasting station of digital broadcasting for distributing the license via the transmission path different from the license management server. Also, the terminal device of the present invention is useful as a personal computer with a communication function, a PDA, an STB and a cellular phone that receives the digital broadcasting.

1-23. (canceled)

24. A content distribution system comprising a license management server, a relay server and a terminal device,
wherein the license management server includes:
a first license generation unit operable to generate, in a first format, a first license for controlling content use in the terminal device;
a modification detection information generation unit operable to generate a digital signature for detecting a modification of the first license and send the generated digital signature to the relay server, depending on a transmission path to the terminal device;
a specification information receiving unit operable to receive an input of format specification information that is an instruction, to the terminal device, for converting a format of a second license to the first format; and
a specification information sending unit operable to send the received format specification information to the relay server, the relay server includes
a second license generation unit operable to generate, in a second format, a second license by adding, to the first license, the digital signature for detecting a modification of the first license, the second format being different from the first format, and add, to the generated second license, the format specification information received by the license management server,
the terminal device includes:
a format conversion unit operable to obtain the second license from the relay server and convert the format of the second license into the first format, according to the format specification information added to the second license;
a judgment unit operable to judge presence or absence of the modification of the first license whose format is converted by the format conversion unit based on the digital signature; and
a use unit operable to use the content according to the first license in the case where the judgment unit judges that no modification is made.

25. The content distribution system according to claim 24,
wherein, in the case where a frequency band of the transmission path is narrower than a predetermined frequency band or a communication speed of the transmission path is slower than a predetermined communication speed, the modification detection information generation unit sends the digital signature to the relay server and instructs the relay server to generate the second license.

26. The content distribution system according to claim 25,
wherein the second license generation unit generates the second license whose data size is smaller than a data size of the first license generated in the first format.

27. The content distribution system according to claim 24,
wherein the license management server includes a first sending unit operable to send the first license to the terminal device,
the relay server includes a second sending unit operable to send the second license to the terminal device via the transmission path different from the transmission path in the case of using the license management server, and
the terminal device obtains the second license from the second sending unit.

28. The content distribution system according to claim 24, further comprising a plurality of servers, one of which is the relay server,
wherein each of the relay servers includes an “n”th license generation unit operable to generate an “n”th (“n” is a natural number that is 2 or greater) license, in an “n”th format, generated by adding, to the first license, the digital signature for detecting the modification of the first license, the “n”th format different from the first format, and
the format conversion unit obtains the “n”th license from one of the relay servers and converts the format of the “n”th license into the first format.

29. A license management server in a content distribution system comprising: the license management server; a relay server; and a terminal device,
wherein the license management server distributes a first license for controlling content use in a terminal device,
the relay server generates, in a second format, a second license by adding, to the first license, a digital signature for detecting a modification of the first license, the second format being different from a format used when the first license is generated, and distributes the second license, and
the terminal device generates the first license by format transformation by obtaining the second license, detects presence or absence of the modification of the generated first license based on the digital signature, and, in the case where no modification is detected, uses the content according to the first license,
the license management server includes:
a first license generation unit operable to generate, in a first format, the first license; and
a modification detection information generation unit operable to generate the digital signature of the first license, send the generated digital signature to the relay server, depending on a transmission path to the terminal device, and instruct the relay server to generate the second license;
a specification information receiving unit operable to receive an input of format specification information that is an instruction, to the terminal device, for converting the format of the second license into the first format;
a specification information sending unit operable to send the received format specification information to the relay server.

30. The license management server according to claim 29,
wherein, in the case where a frequency band of the transmission path is narrower than a predetermined frequency band or a communication speed of the transmission path is lower than a predetermined communication speed, the modification detection information generation unit sends the digital signature to the relay server and instructs the relay server to generate the second license.

31. The license management server according to claim 30,
wherein the relay server generates the second license whose data size is smaller than a data size of the first license generated in the first format.

32. A relay server in a content distribution system comprising: a license management server; the relay server; and a terminal device,
wherein the license management server distributes a first license for controlling content use in a terminal device,
the relay server generates, in a second format, a second license generated by adding, to the first license, a digital signature for detecting a modification of the first license, the second format being different from a format used when the first license is generated, and distributes the second license, and
the terminal device generates the first license by format transformation by obtaining the second license, detects presence or absence of the modification of the generated first license based on the digital signature, and, in the case where no modification is detected, uses the content according to the first license,
the relay server includes:
a second license generation unit operable to generate, in the second format different from the first format, the second license by adding, to the first license generated in the first format, the digital signature of the first license received from the license management server, receive an input of format specification information from the license management server, the format specification information that is an instruction, to the terminal device, for converting the format of the second license to the first format, and add the received format specification information to the generated second license; and
a second sending unit operable to send the generated second license to the terminal device.

33. The relay server according to claim 32,
wherein the second sending unit sends the second license to the terminal device via a transmission path different from the license management server.

34. A terminal device in a content distribution system comprising: a license management server; a relay server; and the terminal device,
wherein the license management server distributes a first license for controlling content use in the terminal device,
the relay server generates a second license generated, in a second format, by adding, to the first license, a digital signature for detecting a modification of the first license, the second format being different from a format used when the first license is generated, and distributes the second license, and
the terminal device uses the content according to the first license by obtaining the second license and generates the first license using format conversion,
the terminal device includes:
a format conversion unit operable to obtain the second license generated in the second format from the relay server, and convert a format of the obtained second license into a first format different from the second format so as to generate the first license according to format specification information that is an instruction to the terminal device for converting the format of the second license to the first format, and that is added to the second license;
a judging unit operable to judge presence or absence of the modification of the generated first license based on the digital signature added to the second license; and
a use unit operable to use the content according to the first license in the case where the judgment unit judges that no modification is made.

35. A license distribution method for use in a content distribution system including a license management server, a relay server and a terminal device, the method comprising:
generating, in a first format, a first license for controlling content use in the terminal device, the generation being executed by the license management server;
generating a digital signature for detecting a modification of the first license and sending the generated digital signature to the relay server, depending on a transmission path to the terminal device, the generating and sending being executed by the license management server;
receiving an input of format specification information that is an instruction, to the terminal device, for converting a format of a second license to the first format, the receiving being executed by the license management server;
sending the received format specification information to the relay server, the sending being executed by the license management server;
generating a second license in a second format different from the first format by adding, to the first license, a digital signature for detecting a modification of the first license, and adding the format specification information received by the license management server to the generated second license, the generation and adding being executed by the relay server;
converting the format of the second license into the first format by obtaining the second license from the relay server, according to the format specification information added to the second license, the conversion being executed by the terminal device;
judging presence or absence of the modification of the first license whose format is converted into the first format based on the digital signature, the judgment being executed by the terminal device; and
using the content according to the first license in the case where it is judged that no modification is made, the use being executed by the terminal device.
